(19) United States
(12) Patent Application Publication
(10) Pub. No.: US 2008/0222989 A1
(43) Pub. Date: Sep. 18, 2008

(54) Metal Roof Truss Connection

(75) Inventors: Leon Willem Greeff, Beaumont, South Australia (AU); Graham John Peacock, South Australia (AU)

Correspondence Address: Ralph C. Francis;Francis Law Group, 1942 Embarcadero, Oakland, CA, 94606, US

(73) Assignee: QUICK FRAME TECHNOLOGIES PTY LTD, Adelaide, South (AU)

(21) Appl. No.: 10/567,280

(22) PCT Filed: Aug. 6, 2004
(86) PCT No.: PCT/AU2004/001045

§ 371 Date: May 20, 2008

(30) Foreign Application Priority Data
Aug. 6, 2003 (AU) 2003904103

(51) Int. Cl. E04C 3/10; F16B 9/00

(52) U.S. Cl. 52/641; 403/188

(57) ABSTRACT

A novel connection means between chord members and stiffening members of a metal roof truss. Each member includes internally pressed circular sections adapted to engage one another and thereby provide for a joint having greater shear strength than conventional joints. Each member includes two parallel side walls adapted to engage one another, this further strengthening the joint in that there are two connecting surfaces, and located between each engaged walls is a cylindrical ferrule adapted to prevent inward deflection of the walls when secured.

### FIELD OF THE INVENTION

The present invention relates to a metal roof truss and, in particular, to the connection means between chord members, and between chord and stiffening members.

### BACKGROUND OF THE INVENTION

Metal roof trusses generally consist of a frame in the form of three chord members arranged in a triangular configuration to support the roof, and internal stiffening members which serve to strengthen the frame. The chord members typically comprise a base chord member and two upper diagonal chord members which join at the roof apex, whilst the stiffening members are typically configured in a triangular web arrangement between the chord members such that each carries a tension or compression force. Chord and stiffening members are manufactured having a range of cross-sections including C-sections, square hollow sections (SHS), rectangular hollow sections (RHS), and rounded hollow sections (RHS), depending on the strength and structural requirements of the truss. The chord and stiffening members exemplified herein are of the C-section type, however, it is to be understood that the present invention may equally well be used on members having alternate cross-sections.

Standard metal roof truss chord members include connecting means at their ends so that the chord members may each be connected to one another, and also at spaced apart intervals along their length so that internal stiffening members may be connected thereto. There are numerous known methods of connecting metal roof truss members, most of which include simple bolt connections.

The problem with known connection means is that they are generally difficult and time consuming to assemble. Roof trusses are generally assembled just prior to installation. As those skilled in the art would realise, after fixing a first end of the stiffening members to a base chord member, one must take care to align the opposed end of the stiffening member with a receiving section of an upper chord member for connection thereto. This can be done in one of two ways. One may fix the first end of the stiffening member to the base chord member in perfect alignment, but is difficult. Another way is to only partially fix the first end so that the opposed end may be rotated into alignment with the receiving portion of the upper chord. In either situation, known connection means are not adequate. There is therefore a need for a more practical connection means between truss members which allows for a first end of each member to be sufficiently secured to another member whilst allowing the free end to be appropriately moved into a position where mounting to a further member is desired.

Furthermore, the resulting joints of existing truss members often lack strength. The members are typically connected through the abutment of single surfaces thereof, this resulting in a relatively weak joint. Furthermore, these abutting surfaces are generally flat thereby providing only lateral restriction. Also, in circumstances where the members are made to shear, the strength of the joint relies solely on a bolt connecting the two members together. Thus, existing connection means between roof truss members result in joints of insufficient shear strength.

It is therefore an object of the present invention to overcome at least some of the aforementioned problems or to provide the public with a useful alternative.

### SUMMARY OF THE INVENTION

Therefore in one form of the invention there is proposed a connection between a first and a second roof truss member, said connection characterised by:

said first member including two parallel and spaced apart longitudinal surfaces wherein at least a portion of said surfaces is laterally disposed from their respective longitudinal surfaces; and
said second member including two parallel and spaced apart longitudinal surfaces wherein at least a portion of said surfaces is correspondingly shaped with said laterally disposed portions of the first member, whereby engagement of said first and second portions allows said second member to rotate relative to said first member whilst preventing said second member from radial movement relative to the first member.

In preference said first and second portions include apertures which coaxially align when said portions are engaged.

In preference said second member is rotatable relative to said first member about a shaft adapted to extend through said coaxial apertures.

Preferably said shaft is in the form of a bolt connection capable of locking said first and second members at a desired angle.

Preferably said connection includes a means to maintain the spaced apart relationship between parallel surfaces of the first member despite tightening of the bolt which urges said surfaces together.

Preferably said first member includes a secondary locking means in the form of two gripping edges associated with said laterally spaced portions of the first member such that when the bolt connection is tightened, the gripping edges grip said parallel and spaced apart longitudinal surfaces of said second member.

Preferably said first member is a chord member of the roof truss.

In preference said second member is a stiffening member of the roof truss.

In a further form of the invention there is proposed a metal roof truss including:

at least one longitudinal stiffening member including two parallel and spaced apart side walls; and
at least one longitudinal chord member also including two parallel and spaced apart side walls whereby at least one section along the length or at the ends of the chord member is adapted to house a first end of said stiffening member or a first end of a further chord member, such that the free end of the stiffening or further chord member is free to rotate.

Preferably said metal roof truss includes a lower chord member adapted to lie substantially flat and parallel to the ground and two upper chord members connected at an apex above said lower chord member and to opposed ends of the lower chord member in a triangular arrangement.

In preference said metal roof truss includes a web of stiffening members that support the upper and lower chord members.

In preference said chord and stiffening members have a substantially C-section profile and further include an indented base and upper edges defining an open channel.

In preference said parallel and spaced apart side walls of the stiffening and chord members extend longitudinally beyond the length of the indented base and upper edges to thereby form parallel and spaced apart end flanges.

Preferably said flanges extend beyond the base and upper edges in a substantially semicircular arrangement whereby the radial centres of each flange also define the radial centres of internally pressed circular sections located at each flange.

In preference each of the parallel and spaced apart side walls of the chord member includes internally pressed circular sections at mounting sections therealong, said internally pressed circular sections being correspondingly shaped with the internally pressed circular sections of the stiffening member parallel flanges.

Preferably when said parallel flanges are received within said parallel side walls, the internally pressed circular sections of each flange engage with corresponding internally pressed circular sections of each parallel side wall, thereby preventing the stiffening member or further chord member from movement along the shear plane between their respective surfaces.

Preferably said section of said chord member adapted to house a first end of the stiffening member or a first end of a further chord member includes splayed upper edges located above and adjacent the internally pressed sections of the chord member, the splayed edges extending substantially upwardly and outwardly and then inwardly toward the parallel and spaced apart side walls of the stiffening member or further chord member.

Preferably each internally pressed circular section of the chord and stiffening members include an aperture at their centre such that when engaged, the internally pressed sections of each member become coaxially aligned.

In preference said stiffening or further chord members are lockable to said chord member using a bolt adapted to extend through co-axially aligned apertures of said internally pressed sections.

Advantageously when said bolt is tightened, the semicircular flanges and side walls are prevented from internally deflecting by a cylindrical ferrule locked there between.

Preferably said cylindrical ferrule is of a diameter slightly greater that the diameter of the internally pressed sections of each semicircular flange.

Preferably just prior to said bolt being tightened, the free end of the stiffening member or further chord member is able to rotate about said bolt. This ensures that the free end of either the further chord member or stiffening member may be adequately aligned with a further receiving section.

In preference when said bolt is tightened, said internally extending splayed edge bites into the side walls of the stiffening member or further chord member thereby acting as a secondary means for preventing shear deflection of the members.

In preference an apex plate joins stiffening members and chord members at the roof truss's upper apex.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 illustrates a side view of a metal roof truss having chord and stiffening members connected in accordance with the present invention;

FIG. 2A illustrates a perspective view of the open surface of a metal roof truss chord member in accordance with the present invention;

FIG. 2B illustrates a perspective view of the closed surface of the metal roof truss chord member of FIG. 1A;

FIG. 2C illustrates a side view of the metal roof truss chord member of FIG. 1A;

FIG. 2D illustrates an end view of FIG. 1A;

FIG. 2E illustrates a top view of FIG. 1A;

FIG. 3A illustrates a perspective view of the open surface of a metal roof truss stiffening member in accordance with the present invention;

FIG. 3B illustrates a perspective view of the closed surface of the metal roof truss stiffening member of FIG. 2A;

FIG. 3C illustrates a side view of the metal roof truss stiffening member of FIG. 2A;

FIG. 3D illustrates an end view of FIG. 2A;

FIG. 3E illustrates a top view of FIG. 2A;

FIG. 4 illustrates an exploded perspective view of the connection means between a chord and stiffening member;

FIG. 5A illustrates a side view of the connection between a chord and stiffening member, and rotation of the stiffening member relative to the chord member;

FIG. 5B illustrates an end view of the connection means between the chord and stiffening member of FIG. 4A;

FIG. 5C illustrates a partially cross-sectional end view of the connection means between the chord and stiffening member of FIG. 4A;

FIG. 6 illustrates a perspective view of a chord member in accordance with a further embodiment of the present invention; and

FIG. 7 illustrates a side view of a metal roof truss having chord and stiffening members connected in accordance with the present invention, and including an apex plate joining the upper ends of some of the stiffening members.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention.

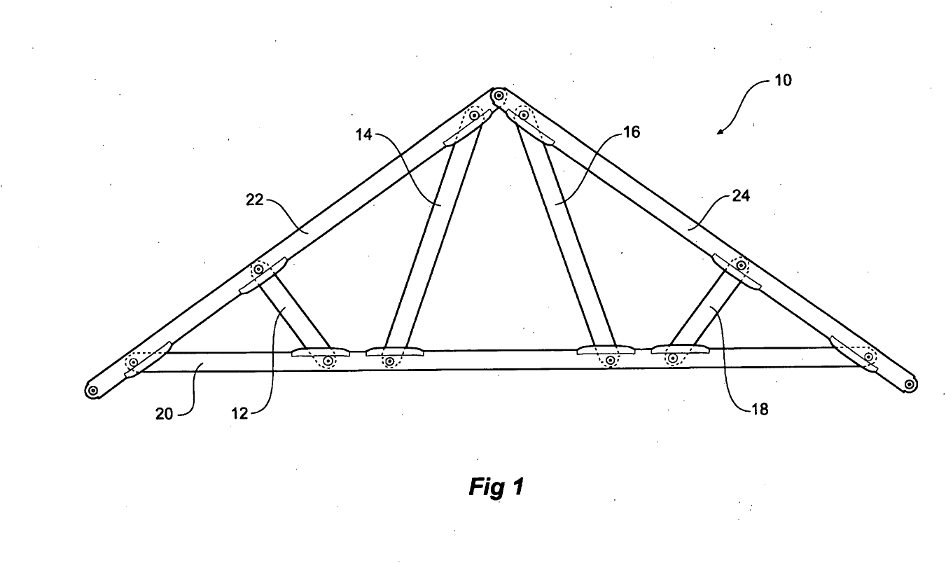

The present invention relates to the connection means of a metal roof truss 10 between stiffening members 12, 14, 16 and 18 and chord members 20, 22 and 24, as shown in FIG. 1. Although the metal roof truss 10 consists of numerous joints between chord and stiffening members, only one of these is explicitly described herein. More specifically, the connection between the end of stiffening member 12 and the lower chord member 20 as shown in FIG. 1 is described. It is to be understood however that this description also applies to the remaining joints also.

Truss 10 includes a triangular frame defined by the lower or base chord member 20 and the two upper diagonal chord members 22 and 24 which form the diagonal sides of the triangular frame. The four stiffening members 12, 14, 16 and 18 of the truss 10 serve to support the chord members. The connection between chord and stiffening members as proposed in the present invention not only prevents lateral motion of the stiffening members relative to the chord members, but also increases the shear strength of each joint. The connection also allow a builder to assemble the truss 10 in a minimum amount of time and with minimal difficulty in that they may simply align a free end of each stiffening member with a receiving section of a chord member by simply rotating the free end until it is correctly aligned with the receiving section. Connection between chord members is also achieved using the connection means of the present invention.

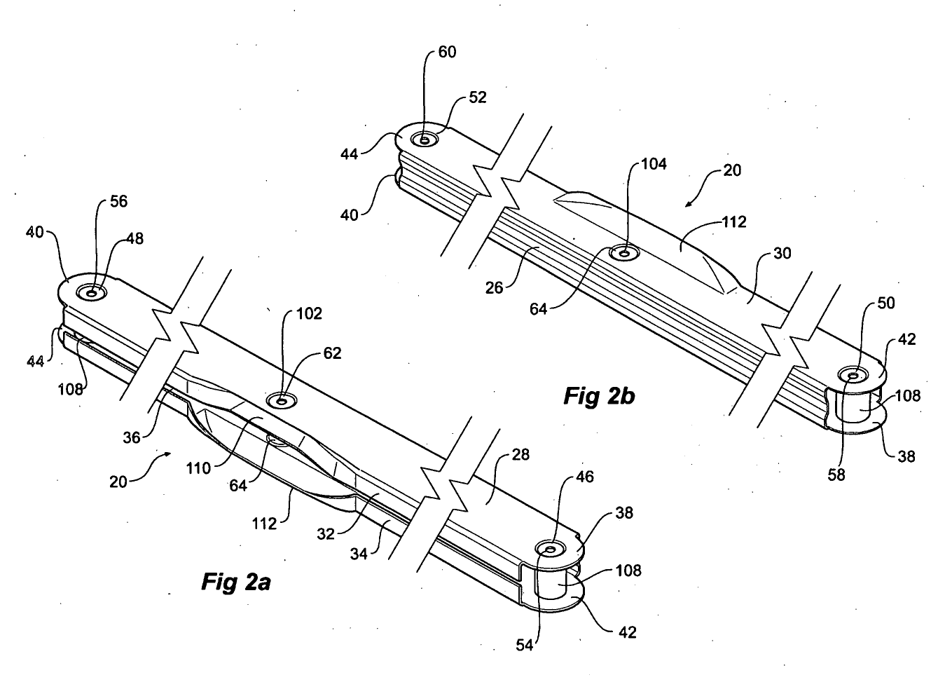

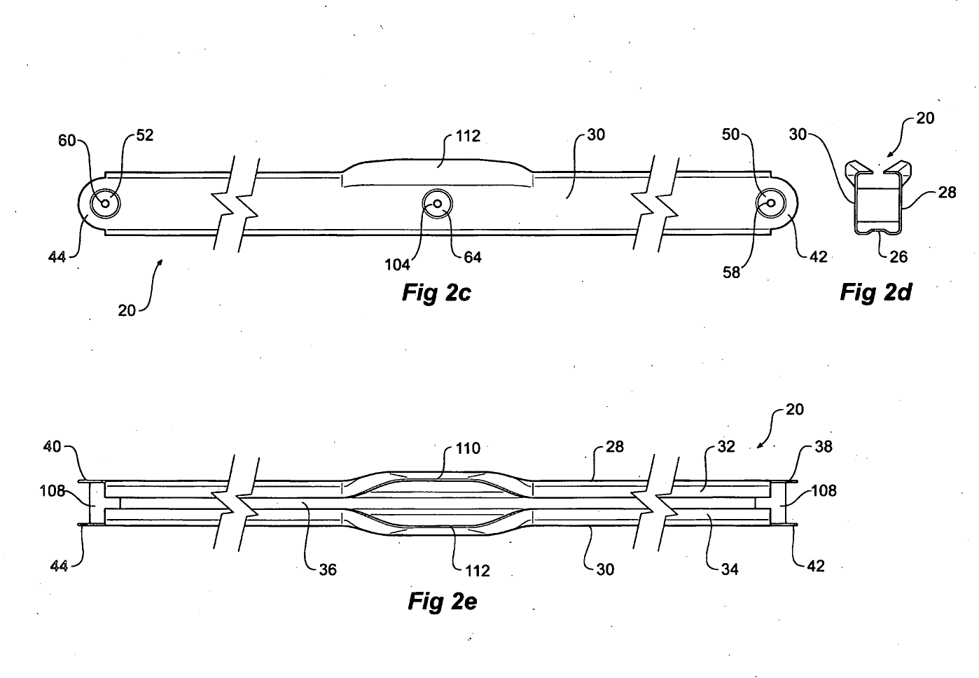

FIGS. 2A-2E illustrate a section of the lower chord member 20 when disconnected from the truss 10. The chord member 20 is made of strip steel that has been extruded into an elongate C-section beam including an indented base 26, side walls 28 and 30, and upper edges 32 and 34 defining an open channel 36. At opposed ends of the chord member 20, side wall 28 extends longitudinally beyond the upper edges 32 and 34 and base 26 to form semicircular flanges 38 and 40, whilst side wall 30 extends longitudinally in the same manner to form semicircular flanges 42 and 44.

Each chord member 20, 22 and 24 includes circular pressed sections 46, 48, 50 and 52 located on each of the flanges 38, 40, 42 and 44 respectively. The centre point of each pressed section 46, 48, 50 and 52 is defined by respective aperture 54, 56, 58 and 60, the apertures also defining the radial centres of each corresponding semicircular flange. The chord member 20 includes similar pressed sections 62 and 64 located at each section along the member to which another chord or stiffening member is to be mounted.

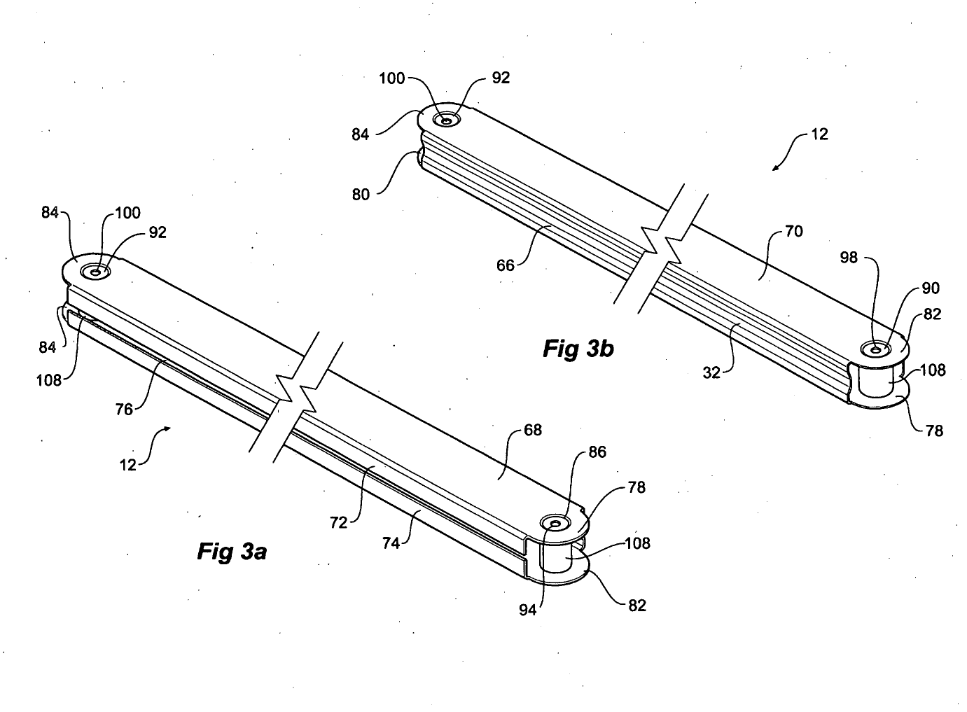

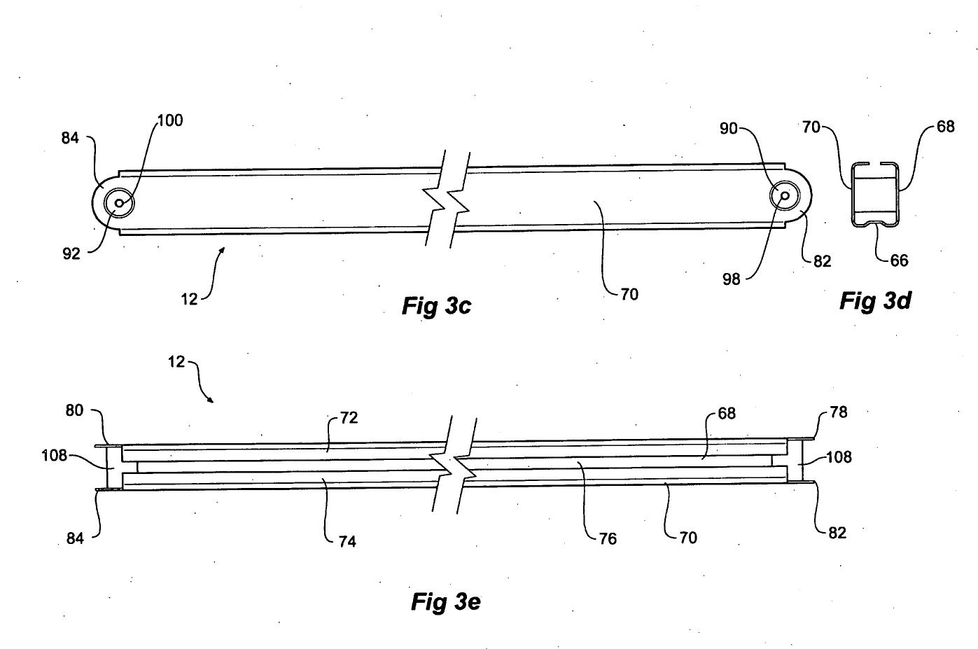

FIGS. 3A-3E illustrate a section of stiffening member 12 when disconnected from truss 10. The stiffening members are made up of the same extruded metal as that of the chord members and include an indented base 66, side walls 68 and 70, upper edges 72 and 74 defining a channel 76, semicircular end flanges 78, 80, 82 and 84, and internally pressed circular sections 86, 88, 90 and 92. In fact, the stiffening members are identical to the chord members of the truss 10 except for the fact that they are not adapted to mount other members along their lengths. Apertures 94, 96, 98 and 100 also exist at the centres of each of the circular pressed sections 86, 88, 90 and 92 respectively. Since the components of the stiffening member are substantially the same as that of the chord members, they will not be described again.

The pressed sections 62 and 64 of the chord member 20 are correspondingly shaped with pressed sections 86 and 90 of the stiffening member 12 respectively. These sections 62 and 64 also include respective central apertures 102 and 104. When the flanges 78 and 82 of stiffening member 12 are inserted between side walls 28 and 30 of the chord member 20 at the appropriate mounting position, the pressed sections of each member become engaged. Once engaged, each aperture of each section becomes coaxially aligned so that a bolt 106 may extend there through. Those skilled in the art would realise that when the pressed sections engage, one section is effectively snapped within the other and prevented from radial movement, or in other words, relative movement of the members along a shear plane.

Those skilled in the art would further realise that tightening of the bolt 106 causes the end of the stiffening member 12 to be effectively secured within the receiving section of chord member 20. When the bolt is further tightened, the flanges 78 and 82 will deflect inwards. For this reason, housed within the semicircular flanges 78 and 82 is a cylindrical ferrule 108. A ferrule 108 is only required at end joints, however, may also be used in joints along the length of the chord members. The diameters of the cylindrical ferrules 108 have a larger diameter than that of the internally pressed sections thereby effectively preventing the ferrules from radial movement also.

Each portion of the chord member 12 adapted to have an end of a stiffening member connected thereto includes splayed edges or openings 110 and 112. The splayed edges 110 and 112 are adapted to extend upwardly and outwardly and then inwardly toward the side walls 68 and 70 of the stiffening member 12. The function of the splayed edges 110 and 112 of the chord member 20 will later be explained in more detail.

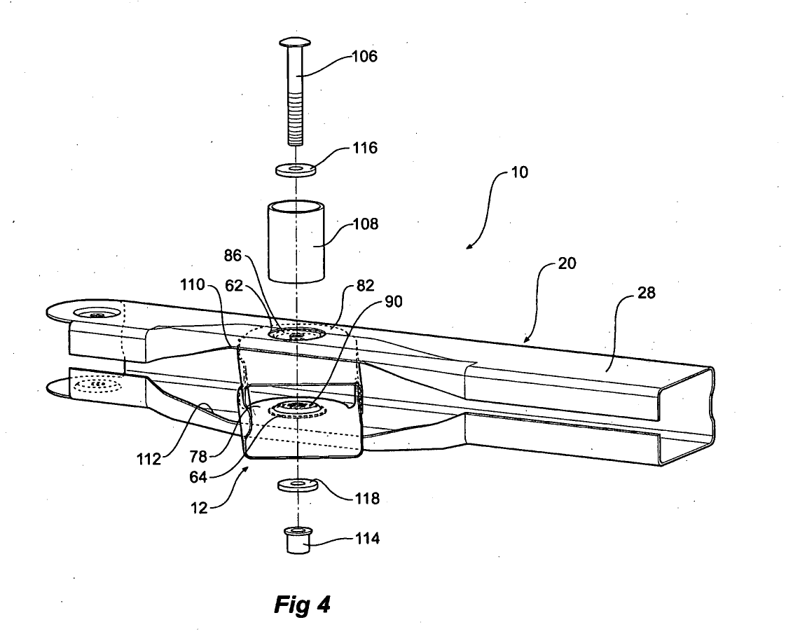

FIG. 4 illustrates clearly the connection means of the present invention, and more particularly, the way in which stiffening member 12 connects with chord member 20. The purpose of the splayed edges 110 and 112 is clear in this drawing. Thus, one end of stiffening member 12 is inserted through the splayed opening of chord member 20. The circular pressed sections 86 and 90 of stiffening member 12, which contain there between ferrule 108, are then manually aligned with the circular pressed sections 62 and 64 respectively of chord member 20, that is, until apertures 94, 98, 102 and 104 are co-axially aligned. Now bolt 106 is placed through the co-axially aligned apertures and fastened on the opposite side with a nut 114. Washers 116 and 118 respectively are used in conjunction with the nut 114 and bolt 106 as would be obvious to those skilled in the art. It is also clear in FIG. 4 how ferrule 108 acts to prevent deflection of semicircular flanges 78 and 82 by the force provided by bolt 106.

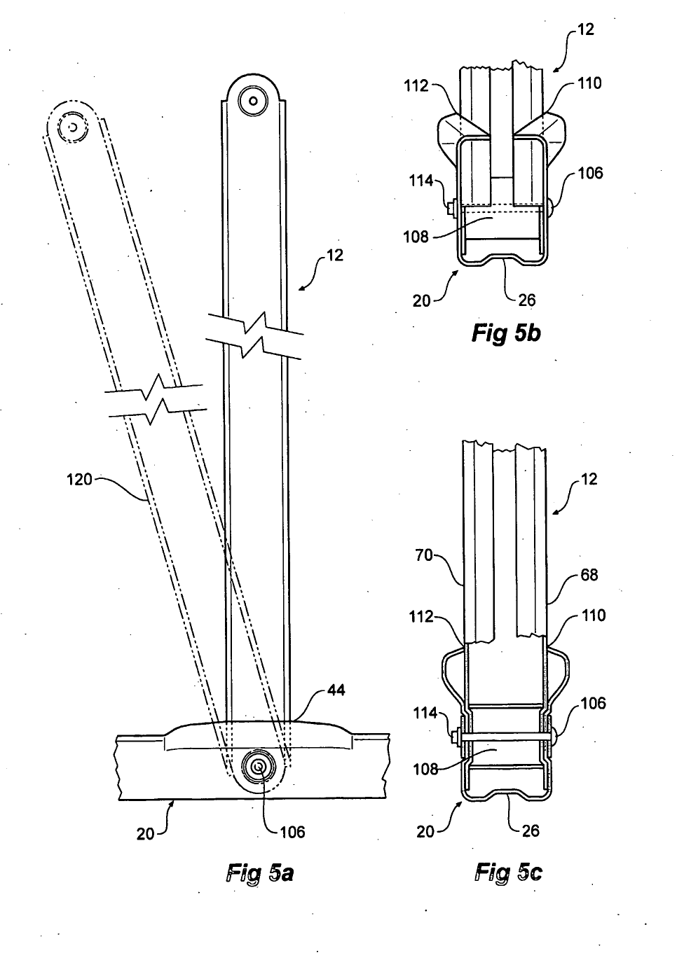

Referring now to FIGS. 5A-5C, it should also be apparent that when assembling the metal roof truss 10 of the present invention, one may simply connect one end of the stiffening member 12 and simply rotate the free end until it is aligned with the connection means of a second chord member. The stiffening member 120 shown in dotted lines in FIG. 4A has been rotated anticlockwise about the pivot point defined by bolt 106. Once the free end of the stiffening member has been manually aligned with a receiving section of a chord member, that is, between splayed edges 110 and 112 then each bolt 106 may be further secured and the remaining members of the truss assembled in the same manner. This significantly aids builders in assembling such roof assemblies.

During further tightening of the bolt 106, the splayed upper edges 110 and 112 provide further strength to the resultant joint in that they bite into the side walls 68 and 70 of the stiffening member 12 thus providing a secondary radial restriction. This can be clearly seen in FIG. 5C. Therefore, the stiffening member 12 is not only locked in place by the bolt connection 106 but also by the biting mechanism provided by the splayed edges 110 and 112. The splayed edges may also provide additional support when rotating the free end of the stiffening member 12 during alignment.

Existing connection means between roof truss members typically comprise a single surface of one member being bolted to a single surface of another member. Thus, the strength of the joint relies on a bolt to prevent lateral and radial movement of one member relative to the other. The metal roof truss connection of the present invention is a much more robust means of connection in that each member is connected along two parallel surfaces which are further nested within one another, and further secured by way of the splayed edges, thereby increasing the overall strength of the joint.

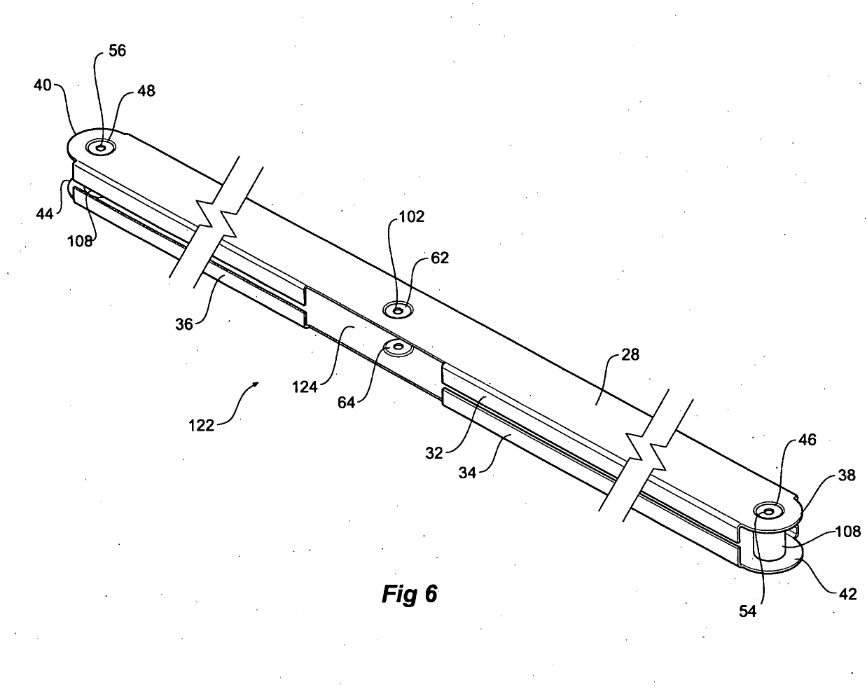

FIG. 6 illustrates an alternate chord member 122 whereby rather than including splayed upper edges 110 and 112, there simply exists a substantially rectangular space or cavity 124 in which a stiffening member is free to rotate. Therefore, in this embodiment, a stiffening member may be connected to the chord member 122 in the same way as previously described, except that there will not be a secondary strengthening means in the form of the splayed upper edges and depends simply on the strength provided by the nesting pressed sections. The parts of the alternate chord member 122 which have not changed include the same references numbers as those used when describing chord member 20.

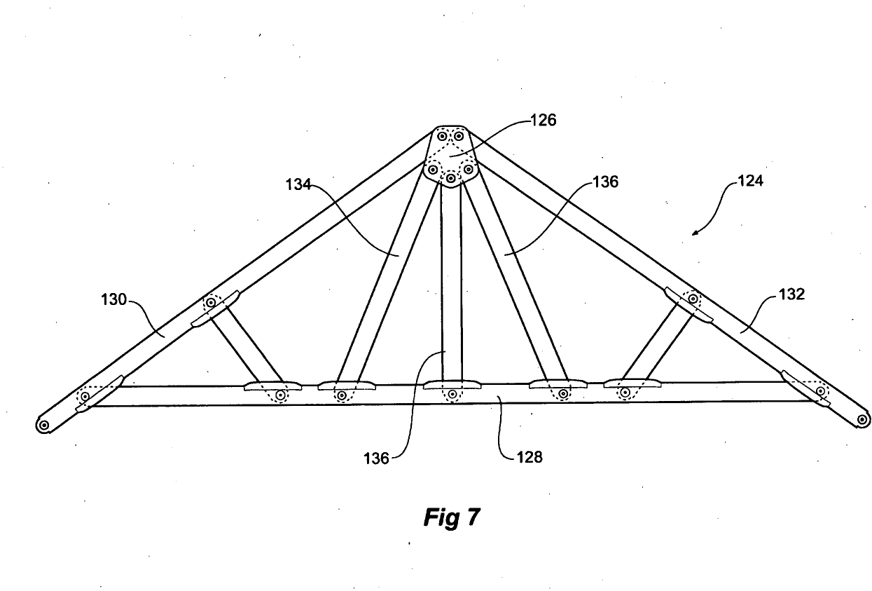

A metal roof truss 124 is illustrated in FIG. 7 including three chord members 128, 130 and 132. The truss 124 further includes an apex plate 126 and an alternate stiffening member arrangement. Apex plate 126 connects the upper ends of chord members 130 and 132 and stiffening members 134, 136 and 138. It is to be understood that apex plate 126 also includes pressed circular sections (not shown) that are correspondingly shaped with the pressed circular sections located on the stiffening and chord members of the truss 124. The apex plate 126 tapers outwards at its base so as to accommodate for the three stiffening members 134, 136 and 138. It is to be understood that the present invention is not limited to this shape of apex plate and that any plate capable of accommodating members having the connection means of the present invention will be adequate.

Furthermore, the above arrangements of truss members are by way of example only and are not intended to limit the present invention to only these arrangements. For example, metal roof truss 10 may well include nine stiffening members rather than four.

In summary, the present invention discloses a novel connection means between various members of a metal roof truss, namely the connection between individual chord members and also the connection between chord and stiffening members. The engagement of internally pressed circular sections of each member provide for a higher shear strength connection in that radial movement of the connecting members is prevented. The inclusion of ferrules at the ends of each member provide for yet further strength in that when the bolt extending through parallel rounded flanges at each end of the stiffening members is tightened, the ends are prevented from inwardly deflecting. Unlike existing connection means, a very secure connection can be achieved in that there are two points of contact between connecting members. A secondary strengthening means may also be used. Preferably this secondary strengthening means is in the form of the splayed openings having edges which bite into the side walls of the member being mounted therein. These features not only provide for a much stronger connection between members of a metal roof truss but also provide for a more efficient assembly procedure with respect to time and complexity in that once members are secured at one end, the free ends may be rotated until they are each appropriately positioned for mounting of a further member thereto.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A construction member for a roof truss, said construction member comprising:
a longitudinal body having at least a base and two upright side walls, wherein each of said upright side walls extends longitudinally beyond said base to thereby form opposed flange portions at longitudinal ends thereof, said opposed flange portions including opposed and co-axially aligned, internally pressed circular sections.

2. The construction member of claim 1, wherein said construction member further includes at least one receival portion along its length, said at least one receival portion having opposed and co-axially aligned, internally pressed circular sections associated with said upright side walls, said side wall internally pressed circular sections being configured to receive and rotatably engage said internally pressed sections of said opposed flange portions of a further construction member.

3. The construction member of claim 1, wherein each of said flange portions extends beyond said base in a substantially semicircular arrangements, whereby the radial centers of each semicircular flange further define the radial centers of said internally pressed circular sections associated therewith.

4. The construction member of claim 3, wherein said internally pressed circular sections of said opposed flange portions are correspondingly shaped with said internally pressed sections of said receival portion, such that when oppose flange portions of a first construction member engage with those of the receival portion of a second construction member, said first construction member is rotatable by way of engagement of corresponding internally pressed circular sections.

5. The construction member of claim 4, wherein each of said internally pressed sections further includes a central apertures, whereby when opposed flange portions of said first construction member engage with those of said receival portion of said second construction member, said apertures of each internally pressed sections become co-axially aligned.

6. The construction member of claim 5, wherein said first and second construction members are further lockable at a predetermined angle with respect to one another.

7. The construction member of claim 6, wherein said first and second construction members are lockable at a predetermined angle with respect to one another using a bolt adapted to extend through co-axially aligned apertures of said internally pressed sections.

8. The construction member of claim 7, wherein each of said opposed flange portions of at least said first construction member includes a ferrule positioned transversely therebetween, said ferrule being configured to prevent internal deflection of said flange portions when said bolt is tightened.

9. The construction member of claim 8, wherein said ferrule is cylindrical and is of a diameter slightly greater than that of said internally pressed sections of opposed flange portions, whereby said ferrule may be maintained therebetween.

10. The construction member of claim 1, wherein at least a longitudinal portion of said construction member further includes two upper edges extending inwards from said upright side walls to thereby form a longitudinal channel therebetween.

11. The construction member of claim 10, wherein said upper edges of said construction member are splayed above and adjacent said at least one receival portion, to thereby allow for the opposed flange portions of a further construction member to be received therethrough.

12. The construction member of claim 11, wherein when a first construction member is received within said receival portion of a second construction member, and a compressive force is applied to said upright side walls of said receival portion, said splayed upper edges of said second construction member bite into said upright side walls of said first construction member and thereby provide a secondary locking means.

13. The construction member of claim 11, wherein said splayed upper edges extend substantially upwardly and outwardly and then inwardly from said upright side walls.

14. The construction member of claim 10, wherein said construction member does not include upper edges above and adjacent said at least one receival portion, to thereby allow for the opposed flange portions of a further construction member to be received therethough.

15. The construction member of claim 1, wherein said base includes a longitudinal indent.

16. A connection for roof truss members, said connection comprising:
a first member including two parallel and spaced apart longitudinal surfaces having a pair of inwardly pressed and transversely aligned circular sections associated with an end thereof; and
a second member including two parallel and spaced apart longitudinal surfaces having a pair of inwardly pressed and transversely aligned circular sections at a predetermined position along the length of said second member, said second member further having two transversely opposed, upper gripping edges above said pair of inwardly pressed circular sections;
said first and second members adapted to be connected by way of engagement of said first member circular sections within said second member circular sections allowing said first and second members to rotate relative to one another, said first member further being lockable at a predetermined angle relative to said second member by applying an inward force on said engaging circular portions, said inward force further causing said upper gripping edges to grip the corresponding longitudinal surfaces of said first member.

17. The connection of claim 16, wherein each of said first and second member circular sections include a central aperture, whereby when two pairs of said circular sections engage one another, said central apertures are coaxially aligned.

18. The connection of claim 17, wherein said second member is rotatable relative to said first member about a shaft adapted to extend through said coaxial apertures.

19. The connection of claim 18, wherein said shaft is in the form of a bolt, which provides said inward force when turned in a tightening direction.

20. The connection of claim 19, wherein said connection includes means to maintain said spaced apart relationship between said parallel surfaces of said first member despite tightening of said bolt.

21. The connection of claim 16, wherein said first member comprises a chord member of the roof truss.

22. The connection of claim 16, wherein said second member comprises a stiffening member of the roof truss.

23. A metal roof truss, comprising:
at least one longitudinal stiffening member having a base, first and second ends, two parallel and spaced apart side walls, and parallel and spaced apart end flanges disposed on at least said first end of said stiffening member, said side walls extending a predetermined distance longitudinally beyond said base to thereby form parallel and spaced apart end flanges; and
at least one longitudinal chord member having a base, two parallel and spaced apart side walls, and at least one receiving section, whereby said at least one receiving section is adapted to receive said end flanges of said stiffening member, said end flanges and said receiving sections including inwardly pressed circular sections configured such that said end flanges and receiving sections rotatably engage.

24. The metal roof truss of claim 23, wherein said end flanges extend beyond said base in a substantially semicircular arrangement and include inwardly pressed circular sections, whereby the radial centers of each said flange also define the radial centers of said inwardly pressed circular sections.

25. The metal roof truss of claim 23, wherein said metal roof truss includes a lower chord member adapted to lie substantially flat and parallel to the ground and two upper chord members connected at an apex above said lower chord member and to opposed ends of said lower chord member in a triangular arrangement.

26. The metal roof truss of claim 25, wherein said metal roof truss includes a web of stiffening members that support said upper and lower chord members.

27. The metal roof truss of claim 23, wherein said chord and said stiffening members further include upper edges extending along at least a portion of said chord and said stiffening members, said upper edges defining an open longitudinal channel therebetween.

28. The metal roof truss of claim 23, wherein said receiving section of said chord member includes splayed upper edges located above and adjacent said inwardly pressed sections, said splayed edges extending substantially upwardly and outwardly and then inwardly toward said parallel and spaced apart side walls of said stiffening member.

29. The metal roof truss of claim 23, wherein each said inwardly pressed circular section of said chord and said stiffening members includes an aperture at its center, whereby when engaged, said internally pressed sections of said chord and said stiffening member become coaxially aligned.

30. The metal roof truss of claim 28, wherein said inwardly pressed sections include co-axially aligned apertures and said stiffening member is lockable to said chord member using a bolt adapted to extend through said co-axially aligned apertures.

31. The metal roof truss of claim 30, including a cylindrical ferrule locked between said semicircular flanges and said side walls and wherein when said bolt is tightened, said semicircular flanges and side walls are prevented from internally deflecting by said cylindrical ferrule.

32. The metal roof truss of claim 30, wherein just prior to said bolt being tightened, the free end of said stiffening member is able to rotate about said bolt.

33. The metal roof truss of claim 30, wherein when said bolt is tightened, said internally extending splayed edge bites into said side walls of said stiffening member thereby acting as a secondary locking means.

34. The metal roof truss of claim 23, wherein an apex plate joins stiffening members and chord members at the roof truss's upper apex.
